(19) United States
(12) Patent Application Publication
(10) Pub. No.: US 2025/0353553 A1
(43) Pub. Date: Nov. 20, 2025

(54) FRONT STRUCTURE OF VEHICLE

(71) Applicant: MAZDA MOTOR CORPORATION, Hiroshima (JP)

(72) Inventors: Satoshi NAKAMURA, Hiroshima (JP); Hiroyuki MIZUOCHI, Hiroshima (JP)

(73) Assignee: MAZDA MOTOR CORPORATION, Hiroshima (JP)

(21) Appl. No.: 19/082,280

(22) Filed: Mar. 18, 2025

(30) Foreign Application Priority Data
May 14, 2024 (JP) 2024-078917

(51) Int. Cl. B62D 25/08

(52) U.S. Cl. CPC B62D 25/085

(57) ABSTRACT

A front structure of a vehicle comprises a pair of right-and-left side frames extending in a longitudinal direction, a cross member provided to extend between the side frames, and an on-board equipment positioned between the side frames, wherein the on-board equipment comprises a first fixation portion fixed to the cross member and a second fixation portion positioned in back of the first fixation portion and fixed to the side frame through a fixation structure in which the on-board equipment is detachable from the side frame when receiving an impact load applied from a vehicle forward side.

### BACKGROUND OF THE INVENTION

The present invention relates to a front structure of a vehicle.

Japanese Patent Laid-Open Publication No. 2020-82948 discloses a front structure of a vehicle which comprises a suspension member fixed to a body frame via a connecting member and a power (electric power) receiving device attached to a lower face of the suspension member and fixed to the body frame via the connecting member.

In the front structure of the vehicle of the above-described patent document, when an external force is applied from a forward side or a rearward side, the connecting member bends downward and thereby the power receiving device connected to the connecting member moves downward, so that a power storage device which is arranged in back of the power receiving device is suppressed from contacting the power receiving device.

According to the front structure of the vehicle of the above-described patent document, since the power receiving device is fixed to a side frame which extends in a vehicle longitudinal direction of the suspension member, the impact-load absorption performance of the side frame which is supposed to be deformed when a collision load is applied from the forward side is hindered (deteriorated), so that an impact load may not be absorbed sufficiently through deformation of the side frame.

A member to hinder the above-described deformation of the side frame is not limited to the power receiving device but any on-board equipment which is arranged between a pair of side frames provided on both sides of the vehicle, such as an auxiliary device, may raise the same problem.

### SUMMARY OF THE INVENTION

An object of the present invention is to provide a front structure of a vehicle which does not hinder the deformation of the side frames even in a case where the on-board equipment is positioned between the right-and-left side frames which are configured to absorb the impact load through their deformation when the impact load is applied.

The present invention is a front structure of a vehicle, comprising a pair of right-and-left side frames extending in a longitudinal direction, a cross member provided to extend between the side frames, and an on-board equipment positioned between the side frames, wherein the on-board equipment comprises a first fixation portion fixed to the cross member and a second fixation portion positioned in back of the first fixation portion and fixed to the side frame through a fixation structure in which the on-board equipment is detachable from the side frame when receiving an impact load applied from a vehicle forward side.

According to the present invention, since the on-board equipment is detached from the side frames at the second fixation portion when the impact load is applied from the vehicle forward side, even in a case where the on-board equipment is positioned between the right-and-left side frames, it can be suppressed that the deformation of the side frames is hindered by the on-board equipment.

Thus, the present invention can provide the front structure of the vehicle which does not hinder the deformation of the side frames even in the case where the on-board equipment is positioned between the right-and-left side frames which are configured to absorb the impact load through their deformation when the impact load is applied.

The present invention will become apparent from the following description which refers to the accompanying drawings.

### BRIEF DESCRIPTION OF THE DRAWINGS

FIG. 1 is a plan view of a front structure of a vehicle according to an embodiment of the present invention.

FIG. 2 is a side view of the front structure of the vehicle according to the embodiment of the present invention.

FIG. 3 is a perspective view of a subframe and a non-contact charger.

FIG. 4 is a plan view of the subframe and the non-contact charger.

FIG. 5 is a perspective view of the non-contact charger alone.

FIG. 6 is a schematic sectional view taken along line VI-VI of FIG. 3.

FIGS. 7A, 7B, 7C are explanatory diagrams of a manner in which an impact load is applied to the subframe from a forward side.

### DETAILED DESCRIPTION OF THE INVENTION

Hereafter, an embodiment of the present invention will be described referring to the accompanying drawings. The following description is mealy about the exemplified embodiment, and therefore the present invention is not be limited in its applications or uses by this.

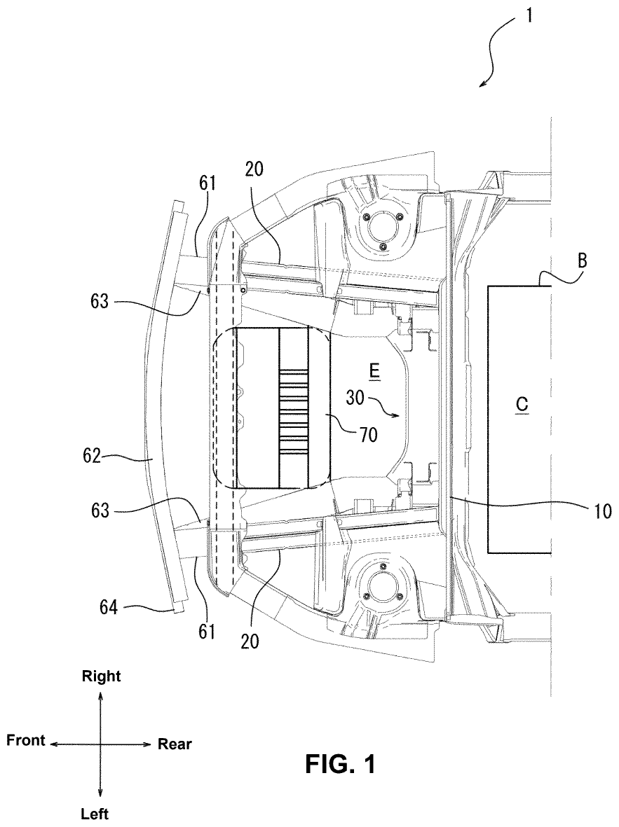

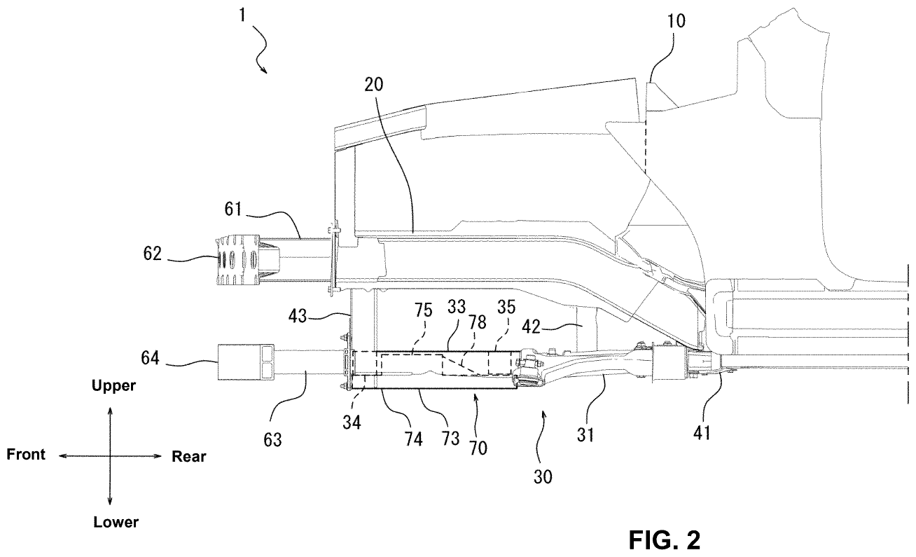

FIGS. 1 and 2 show a front structure 1 of a vehicle according to the embodiment of the present invention. In the present embodiment, the vehicle provided with the front structure 1 of the present invention is an electric automobile.

As shown in FIGS. 1 and 2, the front structure 1 of the electric automobile comprises a dash panel 10 which partitions a cabin C from an engine E where a drive source, such as a motor, is arranged, a pair of right-and-left front side frames 20 which extend forward from the dash panel 10, and a subframe (suspension cross member) 30 which is arranged below the front side frames 20.

A main crash can 61, which is made of a cylindrical body or the like to absorb an impact load applied from a vehicle forward side, extends forward at each front end of the front side frames 20. The pair of right-and-left main crash cans 61 are interconnected by a bumper reinforcement 62 which extends in a vehicle width direction.

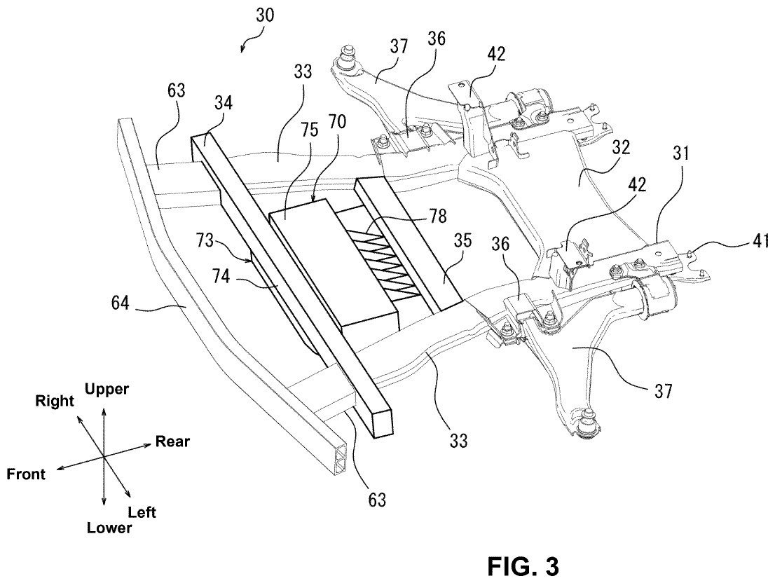

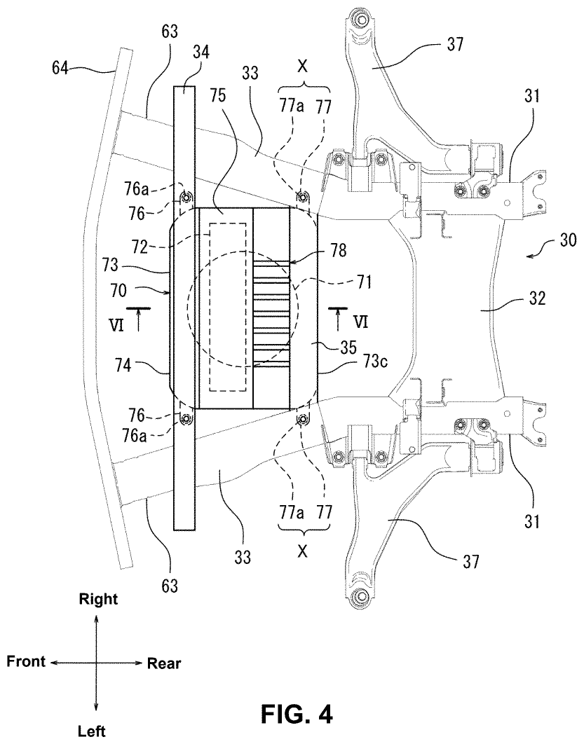

As shown in FIGS. 3 and 4, the subframe 30 comprises a pair of right-and-left suspension-link support portions (hereafter, referred to as “link support portions” in some cases) 31, a main cross member 32 which interconnect the link support portions 31 in the vehicle width direction, a pair of right-and-left extension side frames (hereafter, referred to as “side frames”) 33 which extend forward from respective front ends of the link support portions 31, and a front cross member 34 and a rear cross member 35 which interconnect respective front ends and respective rear ends of the side frames 33 in the vehicle width direction.

A sub crash can 63, which is made of a cylindrical body or the like, is attached to each front end of the side frames 33 via each set plate or the like. Respective front ends of a pair of right-and-left sub crash cans 63 are interconnected by a beam member 64 which extends in the vehicle width direction.

Each of the link support portions 31 is of a cylindrical member extending in the longitudinal direction. The right-and-left link support portions 31 extend roughly in parallel to each other. A front suspension arm 37 is attached to an outward side, in the vehicle width direction, of the link support portion 31 via a bracket 36. A vehicle fixation portion 41 to fix the subframe 30 to a floor frame is provided at a rear end of each of the link support portions 31, and a rear-side pole-shaped member 42 to connect the front side frame 20 and the subframe 30 is provided at a middle portion, in the longitudinal direction, of each of the link support portions 31 (at a front end of the main cross member 32).

The main cross member 32 extends in the vehicle width direction and interconnects the right-and-left link support portions 31 over a range from respective rear end portions to the respective middle portions of the link support portions 31. The main cross member 32 is of a flat shape with its smaller thickness, in the vertical direction, compared to its length or width, in the longitudinal direction or in the vehicle width direction. The main cross member 32 is joined to an inward side, in the vehicle width direction, and an upper face of each of the link support portions 31 at both end portions, in the vehicle width direction, thereof by welding or the like.

The side frame 33 is of a cylindrical member extending in the longitudinal direction. The side frame 33 is arranged such that its front portion is located on the outward side, in the vehicle width direction, of its rear portion. The distance between the both-side side frames 33 becomes wider toward the vehicle forward side. A rear end of the side frame 33 is joined to the front end of the link support portion 31 by welding or the like.

The front cross member 34 is of a cylindrical member extending in the vehicle width direction. The front cross member 34 has a rectangular closed-cross section perpendicular to the vehicle width direction. The front cross member 34 is provided to extend between the respective front ends of the side frames 33. The front cross member 34 is fixed to the side frames 33 at its both outside parts by fastening members, such as bolts or the like.

A pair of right-and-left front-side pole members 43 which stand upward from an upper face 34d of the front cross member 34 in a pole shape are provided at the both end portions, in the vehicle width direction, of the front cross member 34. An upper end of each of the front-side pole members 43 is joined to a lower face of a front-end portion of the front side frame 20 by the fastening member or the like.

The rear cross member 35 is of another cylindrical member extending in the vehicle width direction. The rear cross member 35 has another rectangular closed-cross section perpendicular to the vehicle width direction. The rear cross member 35 is provided to extend between the respective rear ends of the side frames 33. The rear cross member 35 is fixed to respective inward side faces, in the vehicle with direction, of the side frames 33 at its both outside parts by welding or the like.

As shown in FIG. 1, the vehicle comprises a battery B to drive an electric drive mechanism, not illustrated, and a non-contact charger 70 to receive power (electric power) from an external side and supply the received power to the battery B. In the present embodiment, the battery B is arranged on the side of the cabin C, and the non-contact charger 70 is arranged in the engine room E. The battery B and the non-contact charger 70 are electrically connected so as to receive and supply the power therebetween.

The non-contact charger 70 and its fixation structure X will be described referring to FIGS. 1-6. As shown in FIGS. 1 and 2, the non-contact charger 70 is arranged between the front cross member 34 and the rear cross member 35.

As shown in FIG. 4, the non-contact charger 70 comprises a power-receiving coil 71 which receives the magnetic flux generated by supplying the electricity to a power-supply coil embedded at a road surface of a parking lot or the like, for example, generates the electricity by means of the electromagnetic induction, and store the power at the battery B, a rectifier 72 which rectifies the electricity of the power-receiving coil 71, and a casing 73 which stores the power-receiving coil 71 and the rectifier 72 therein.

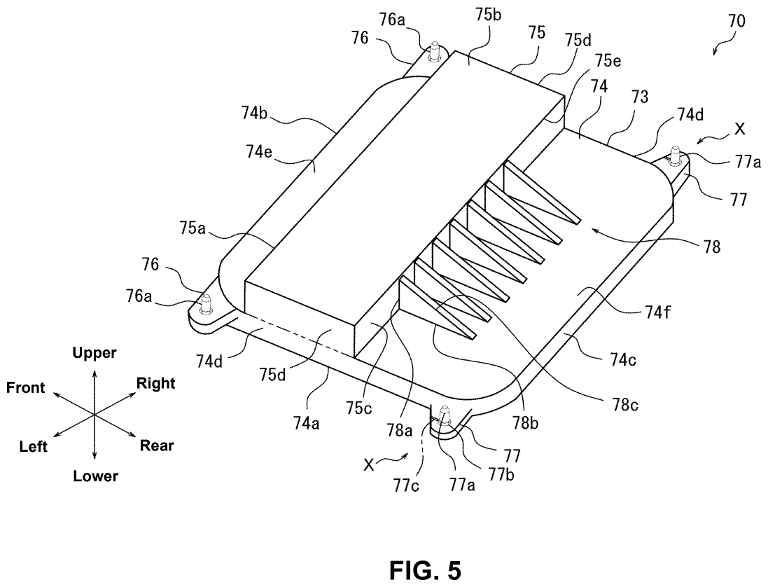

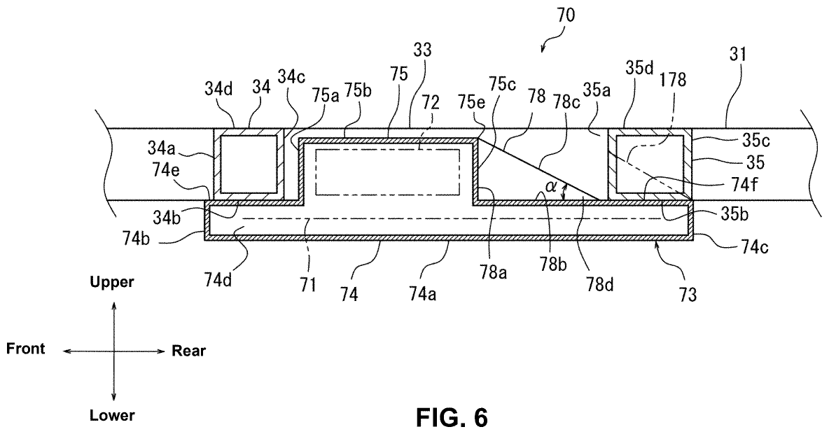

As shown in FIGS. 5 and 6, the casing 73 comprises a body portion 74 where the power-receiving coil 71 is stored, a protrusion portion 75 where the rectifier 72 is stored and which protrudes upward beyond the body portion 74, fixation portions 76, 77 which protrude in a flange shape, in the vehicle width direction, from a peripheral edge portion of the body portion 74 and fixes the non-contact charger 70 to the subframe 30, and an inclination portion 78 which connects an upper face of the body portion 74 and a rear face of the protrusion portion 75 in a braced shape.

As shown in FIG. 5, the body portion 74 is formed in a roughly rectangular-parallelepiped shape, which is of a flat shape with its small thickness in the vertical direction. The body portion 74 comprises a roughly rectangular-shaped bottom face portion 74a extending substantially horizontally, a front face portion 74b extending upward from a front edge of the bottom face portion 74a, a rear face portion 74c extending upward from a rear edge of the bottom face portion 74a, a side face portion 74d extending upward from right-and-left both-side side edges of the bottom face portion 74a, a front-upper face portion 74e extending rearward from an upper edge of the front face portion 74b, and a rear-upper face portion 74f extending forward from an upper edge of the rear face portion 74c. The front-upper face portion 74e has a longitudinal width which is narrower than the rear-upper face portion 74f. The protrusion portion 75 is arranged between the front-upper face portion 74e and the rear-upper face portion 74f.

As shown in FIGS. 5 and 6, the protrusion portion 75 has the rectangular parallelepiped shape having its width longer than its longitudinal length. The protrusion portion 75 is arranged at an offset position slightly located forward from a central portion, in the longitudinal direction, of the body portion 74. The protrusion portion 75 comprises a front face portion 75a extending upward from a rear edge of the front-upper face portion 74e, an upper face portion 75b extending rearward from an upper edge of the front face portion 75a, a rear face portion 75c extending downward from a rear edge of the upper face portion 75b, and a side face portion 75d extending downward from both-side edge portions of the upper face portion 75b and connecting the front face portion 75a and the rear face portion 75c.

The fixation portions 76, 77 protrude outward, in the vehicle width direction, from the side face portion 74d of the body portion 74. The fixation portions 76, 77 comprise the front-side fixation portions (first fixation portion) 76 which are respectively provided at a front-right side and a front-left side of the body portion 74 and the rear-side fixation portions (second fixation portion) 77 which are respectively provided at a rear-right side and a rear-left side of the body portion 74.

The inclination portion 78 is comprised of plural plate members which are of a rectangular shape in a side view. The inclination portion 78 is arranged between the rear face portion 75c of the protrusion portion 75 and the rear-upper face portion 74f of the body portion 74. The inclination portion 78 is configured such that its forward side is located at a higher level. The plural plate members 78 are arranged, in the vehicle width direction, at regular intervals from a central portion, in the vehicle width direction, of the body portion 74. In the present embodiment, the inclination portion 78 is made of radiator fins to cool the non-contact charger 70.

Each of the plate members constituting the inclination portion 78 includes a vertical side portion 78a extending vertically along the rear face portion 75c, a bottom side portion 78b extending rearward from a lower end of the vertical side portion 78a along the rear-upper face portion 74f, and an inclined side portion 78c connecting an upper end of the vertical side portion 78a and a rear end of the bottom side portion 78b.

The vertical side portion 78a has substantially the same height as the rear face portion 75c of the protrusion portion 75. The bottom side portion 78b extends from the rear face portion 75c to a central portion, in the longitudinal direction, of the rear-upper face portion 74f. The inclined side portion 78c rises toward the forward side from a center, in the longitudinal direction, of the rear-upper face portion 74f up to the rear-upper edge portion 75e of the protrusion portion 75. In the present embodiment, an angle a between the inclined side portion 78c and the bottom side portion 78b is set at 20° or more and 45° or less.

As shown in FIGS. 4 and 6, the body portion 74 is positioned between the side frames 33 in the vehicle width direction and provided to extend between the front cross member 34 and the rear cross member 35 as a rearward member.

The front-upper face portion 74e of the body portion 74 overlaps the front cross member 34 in the longitudinal direction and is positioned below the front cross member 34. The longitudinal position of the front face portion 74b of the body portion 74 substantially matches a front face 34a of the front cross member 34. The longitudinal size (measures) of the front-upper face portion 74e substantially matches the front cross member 34. In the present embodiment, the body portion 74 is fixed to the front cross member 34 at the front-side fixation portions 76 in a state where the front-upper face portion 74e contacts a lower face 34b of the front cross member 34.

At least part of the rear-upper face portion 74f of the body portion 74 overlaps the rear cross member 35 in the longitudinal direction, and is located below the rear cross member 35. The longitudinal position of the rear face portion 74c of the body portion 74 almost matches a rear face 35c of the rear cross member 35. The longitudinal size (measures) of the rear-upper face portion 74f is larger than the rear cross member 35, and an inclined face 78 is arranged in the vicinity of the front face 35a of the rear cross member 35. In the present embodiment, the body portion 74 is fixed to the side frames 33 at the rear-side fixation portions 77 in a state where the rear-upper face portion 74f contacts a lower face 35b of the rear cross member 35.

As shown in FIG. 6, the protrusion portion 75 is arranged between the front cross member 34 and the rear cross member 35 in the longitudinal direction. The protrusion portion 75 overlaps the front cross member 34 and the rear cross member 35 in the vertical direction. The vertical position of the protrusion portion 75 and the vertical position of the upper faces 34d, 35d of the front-and-rear cross members 34, 35 match each other roughly.

The front face portion 75a of the protrusion portion 75 is provided to face the rear face 34c of the front cross member 34 from behind. The front face portion 75a of the protrusion portion 75 faces the front cross member 34. The rear face portion 75c of the protrusion portion 75 is positioned in front of the rear cross member 35.

The inclination portion 78 is arranged in front of the rear cross member 35. More specifically, a rear end 78d of the inclination portion 78 extends to the vicinity of the rear cross member 35. In other words, the rear cross member 35 is arranged in the vicinity of the rear end 78d of the inclination portion 78.

In the present embodiment, the meaning of the expression of “the vicinity of the rear end 78d of the inclination portion 78” includes a situation where the rear cross member 35 comes to contact the inclined portion 78 when a specified impact load (e.g., the load is applied to a test vehicle body in the full-lap frontal-collision test, the offset frontal-collision test, or the like in JNCAP) is applied from the vehicle forward side. Therefore, the rear cross member 35 may be separated vertically from the inclination portion 78 and overlap the rear end 78d of the inclination portion 78 in the longitudinal direction or the rear cross member 35 may be totally separated from the inclination portion 78.

As shown in FIG. 4, the front-side fixation portion 76 is provided to protrude outward, in the vehicle width direction, from the front-side side face portion 74d of the body portion 74. The front-side fixation portion 76 is located below the front cross member 34 and fixed to the front cross member 34 via a front fastening member 76a, such as a bolt. The front-side fixation portion 76 and the front cross member 34 are fastened together by inserting the front fastening member 76a into those members 76, 34 in their overlapping state and making the front fastening member 76a be welded to a weld nut or the like which are provided at the front cross member 34, for example.

The rear-side fixation portion 77 is provided to protrude outward, in the vehicle width direction, from the rear-side side face portion 74d of the body portion 74. The rear-side fixation portion 77 is located below a rear-end side of the side frame 33 and fixed to side frame 33 via a rear fastening member 77a, such as a bolt. The non-contact charger 70 is fixed to the subframe 30 by inserting the rear fastening member 77a into the rear-side fixation portion 77 and the side frame 33 in their vertical-overlapping state from below and making the rear fastening member 77a be welded to a weld nut or the like which are provided at the rear cross member 35, for example.

The rear-side fixation portion 77 has the fixation structure X which is detachable due to the impact load applied from the vehicle forward side. The fixation structure X is configured to get broken when the impact load is applied from the vehicle forward side. In the present embodiment, the size (strength) of the rear fastening member (bolt) 77a is set such that when the impact load is applied from the vehicle forward side, the rear fastening member 77a gets broken because of tension and/or shear, so that the rear-side fixation portion 77 can be detached from the side frame 33. The strength of the rear fastening member 77a is smaller than that of the front fastening member 76a. The rear fastening member 77a may be made of a bolt which is configured such that its base portion can get broken due to the impact load applied from the vehicle forward side, for example.

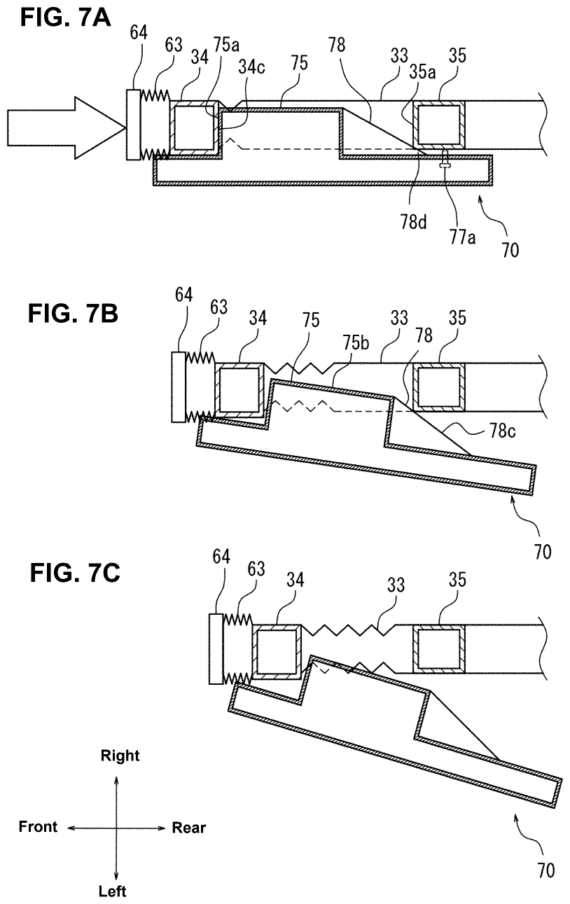

According to the above-described front structure 1 of the vehicle, when the impact load is applied from the vehicle forward side, as shown in FIG. 7A, the beam member 64 and the sub crash cans 63 crush and move back, so that the side frames 33 start their crushing deformation and moving back. When the side frames 33 move back, the front cross member 34 fixed to the front end portions of the side frames 33 moves back. The rear face 34c of the front cross member 34 moving back contacts the front face portion 75a of the protrusion portion 75 and thereby part of the impact load is transmitted to the non-contact charger 70, so that the load acts on the rear fastening members 77a of the rear-side fixation portions 77 in a shearing direction. Thereby, the rear fastening members 77a as the fixation structures X between the rear-side fixation portions 77 and the side frames 33 get broken, so that joining of the rear fastening members 77a and the side frames 33 is released.

As shown in FIG. 7B, when the non-contact charger 70 retreats, the inclined side portions 78c of the inclination portion 78 and the rear cross member 35 contact each other, and the non-contact charger 70 moves downward and rearward relative to the rear cross member 35. Herein, since the moving of the rear cross member 35 performs so as to push down the non-contact charger 70, the fastening members 77a fastened in the vertical direction are drawn down from the side frames 33, so that the non-contact charger 70 gets detached from the side frames 30.

As shown in FIG. 7C, as the crushing deformation of the side frames 33 progresses, the non-contact charger 70 moves rearward such that the rear cross member 35 is located at the upper face portion 75b of the protrusion portion 75 by guiding of the inclination portion 78. Thereby, since the protrusion portion 75 moves below the rear cross member 35, it can be suppressed that the crushing deformation of the side frames 33 is hindered like a case where the protrusion portion 75 gets stuck between the front cross member 34 and the rear cross member 35.

The front structure 1 of the vehicle according to the above-described embodiment performs the following effects.

The front structure 1 of the vehicle comprises a pair of right-and-left side frames 33 extending in the longitudinal direction, the front cross member 34 provided to extend between the side frames 33, and the non-contact charger 70 as an on-board equipment positioned between the side frames 33, wherein the non-contact charger 70 comprises the front-side fixation portion 76 fixed to the front cross member 34 and the rear-side fixation portion 77 positioned in back of the front fixation portion 76 and fixed to the side frames 33 through the fixation structure in which the non-contact charger 70 is detachable from the side frames 33 when receiving the impact load applied from the vehicle forward side.

According to the present embodiment, since the non-contact charger 70 is detached from the side frames 33 at the rear fixation portion 77 when the impact load is applied from the vehicle forward side, even in a case where the non-contact charger 70 is positioned between the right-and-left side frames 33, it can be suppressed that the deformation of the side frames 33 is hindered by the non-contact charger 70.

The front structure 1 further comprises the rear cross member 35 (the suspension cross member 30) as the rearward member arranged in back of the front cross member 34, wherein the non-contact charger 70 includes the guide portion 78 to move the non-contact charger 70 downward when the non-contact charger 70 and the rear cross member 35 contact each other due to the impact load applied from the vehicle forward side.

According to this structure, the non-contact charger 70 can be moved downward and get detached properly when the impact load is applied from the vehicle forward side.

The guide portion is provided at the non-contact charger 70, and the guide portion is the inclination portion 78 which faces the front face 35a of the rear cross member 35 and is inclined such that its front side is inclined upward further.

According to this structure, the non-contact charger 70 can be made to move downward below the rear cross member 35 by the inclination portion 78 easily when the impact load is applied from the vehicle forward side, so that detachment of the non-contact charger 70 from the side frames 33 can be promoted.

The rear cross member 35 is arranged in the vicinity of the rear end of the inclination portion 78.

According to this structure, when the non-contact charger 70 moves rearward, the rear cross member 35 can be made to contact properly by the inclination portion 78.

The rear fastening member 77a of the rear-side fixation portion 77 (fixation structure X) is configured to get broken when the impact load is applied from the vehicle forward side.

According to this structure, the rear fastening member 77a is broken by the impact load applied from the vehicle forward side, so that the non-contact charger 70 can be detached from the side frames 33 easily.

The non-contact charger 70 comprises the protrusion portion 75 having the face which faces the rear face 34c of the front cross member 34.

According to this structure, since the front cross member 34 pushes back the front-side bottom face portion 74a and the projection portion 75 of the non-contact charger 70, the non-contact charger 70 can be detached from the side frames 33 easily.

The non-contact charger 70 comprises the rear-upper face portion 74f extending rearward from the protrusion portion 75, and the inclination portion 78 is provided to stand toward the rear-upper edge portion 75e of the protrusion portion 75 from the rear-upper face portion 74f.

According to this structure, the rear cross member 35 can be easily made to move to the upper face portion 75b of the protrusion portion 75 of the non-contact charger 70 when the impact load is applied from the vehicle forward side. It can be suppressed that a step difference between the rear face portion 75c of the protrusion portion 75 and the inclination portion 78 occurs and thereby the moving of the rear cross member 35 is hindered like a situation where the inclination portion 78 is located below the rear-upper edge portion 75e of the protrusion portion 75.

The rear cross member 35 is part of the suspension cross member (subframe) 30 to support the suspension.

According to this structure, the non-contact charger 70 can be detached from the side frames 33 by utilizing the suspension cross member (subframe) 30 without providing any other particular member.

The guide portion 78 is the radiator fin to cool the non-contact charger 70.

According to this structure, the guide portion 78 can be configured by using the radiator fin.

Herein, the present invention is not to be limited to the above-described embodiment, and any modifications are applicable.

While the present embodiment is configured such that the rear fastening member 77a of the rear-side fixation portion 77 gets broken due to the impact load applied from the vehicle forward side, a slit portion 77c, which is shown by a two-dotted broken line in FIG. 5, may be provided such that it extends forward from a hole 77b of the rear-side fixation portion 77 where the rear fastening member 77a is inserted, for example. Thereby, when the impact load is applied from the vehicle forward side, the non-contact charger 70 moves rearward and the rear fastening member 77a passes through the slit portion 77c, then gets detached from the rear-side fixation portion 77. Consequently, fastening of the rear-side fixation portion 77 and the side frame 33 is released.

While it is provided at the non-contact charger 70 (casing 73) in the present embodiment, as shown by a two-dotted broken line in FIG. 6, the guide portion 78 may be formed by configured the rear cross member 35 such that it is inclined forward and upward, or an inclined portion may be attached in front of the rear cross section 35.

Further, the upper end of the inclined side portion 78c is positioned at the upper-rear edge portion of the protrusion portion 75 in the present embodiment. However, the upper end of the inclined side portion 78c may be positioned below the upper-rear edge portion as long as its position does not hinder the downward-and-rearward moving of the non-contact charger 70 by preventing the rear cross member 35 from contacting the step difference generated between the rear face portion 75c of the protrusion portion 75 and the inclined side portion 78c when the impact load is applied.

### ADDITIONAL NOTES

The present invention includes the following aspects.

### First Aspect

The front structure of the vehicle, comprising a pair of right-and-left side frames extending in the longitudinal direction, the cross member provided to extend between the side frames, and the on-board equipment positioned between the side frames, wherein the on-board equipment comprises the first fixation portion fixed to the cross member and the second fixation portion positioned in back of the first fixation portion and fixed to the side frame through the fixation structure in which the on-board equipment is detachable from the side frame when receiving the impact load applied from the vehicle forward side.

### Second Aspect

The front structure of the vehicle further comprises the rearward member arranged in back of the cross member, wherein the on-board equipment and/or the rearward member include the guide portion to move the on-board equipment downward when the on-board equipment and the rearward member contact each other due to the impact load applied from the vehicle forward side.

### Third Aspect

The guide portion is provided at the on-board equipment, and the guide portion is the inclination portion which faces the front face of the rearward member and is inclined such that its front side is inclined upward further.

### Fourth Aspect

The rearward member is arranged in the vicinity of the rear end of the inclination portion.

### Fifth Aspect

The fixation structure is configured to get broken when the impact load is applied from the vehicle forward side.

### Sixth Aspect

The on-board equipment comprises the front-upper face portion fixed to the lower face of the cross member and the protrusion portion having the face which faces the rear face of the cross member.

### Seventh Aspect

The on-board equipment comprises the rear-upper face portion extending rearward from the protrusion portion, and the inclination portion is provided to stand toward the rear-upper edge portion of the protrusion portion from the rear-upper face portion.

### Eighth Aspect

The rearward member is the suspension cross member to support the suspension.

### Ninth Aspect

The on-board equipment is the non-contact charger, and the guide portion is the radiator fin to cool the non-contact charger.

What is claimed is:

1. A front structure of a vehicle, comprising:
a pair of right-and-left side frames extending in a longitudinal direction;
a cross member provided to extend between the side frames; and
an on-board equipment positioned between the side frames,
wherein said on-board equipment comprises a first fixation portion fixed to said cross member and a second fixation portion positioned in back of said first fixation portion and fixed to said side frame through a fixation structure in which the on-board equipment is detachable from the side frame when receiving an impact load applied from a vehicle forward side.

2. The front structure of the vehicle of claim 1, further comprising a rearward member arranged in back of said cross member, wherein said on-board equipment and/or said rearward member include a guide portion to move the on-board equipment downward when the on-board equipment and the rearward member contact each other due to the impact load applied from the vehicle forward side.

3. The front structure of the vehicle of claim 2, wherein said guide portion is provided at said on-board equipment, and the guide portion is an inclination portion which faces a front face of said rearward member and is inclined such that a front side thereof is inclined upward further.

4. The front structure of the vehicle of claim 3, wherein said rearward member is arranged in the vicinity of a rear end of said inclination portion.

5. The front structure of the vehicle of claim 1, wherein said fixation structure is configured to get broken when the impact load is applied from the vehicle forward side.

6. The front structure of the vehicle of claim 3, wherein said on-board equipment comprises a front-upper face portion fixed to a lower face of said cross member and a protrusion portion having a face which faces a rear face of the cross member.

7. The front structure of the vehicle of claim 6, wherein said on-board equipment comprises a rear-upper face portion extending rearward from said protrusion portion, and said inclination portion is provided to stand toward a rear-upper edge portion of said protrusion portion from said rear-upper face portion.

8. The front structure of the vehicle of claim 2, wherein said rearward member is a suspension cross member to support a suspension.

9. The front structure of the vehicle of claim 2, wherein said on-board equipment is a non-contact charger, and said guide portion is a radiator fin to cool said non-contact charger.

10. The front structure of the vehicle of claim 2, wherein said fixation structure is configured to get broken when the impact load is applied from the vehicle forward side.

11. The front structure of the vehicle of claim 3, wherein said fixation structure is configured to get broken when the impact load is applied from the vehicle forward side.

12. The front structure of the vehicle of claim 4, wherein said fixation structure is configured to get broken when the impact load is applied from the vehicle forward side.

13. The front structure of the vehicle of claim 3, wherein said rearward member is a suspension cross member to support a suspension.

14. The front structure of the vehicle of claim 4, wherein said rearward member is a suspension cross member to support a suspension.

15. The front structure of the vehicle of claim 3, wherein said on-board equipment is a non-contact charger, and said guide portion is a radiator fin to cool said non-contact charger.

16. The front structure of the vehicle of claim 4, wherein said on-board equipment is a non-contact charger, and said guide portion is a radiator fin to cool said non-contact charger.
